(19) United States
(12) Patent Application Publication
(10) Pub. No.: US 2020/0129001 A1
(43) Pub. Date: Apr. 30, 2020

(54) Automatic Drip Beverage Maker With Display on Brew Basket Assembly

(71) Applicant: Hamilton Beach Brands, Inc., Glen Allen, VA (US)

(72) Inventors: Mark K. Romandy, Midlothian, VA (US); Guoyao Ye, Glen Allen, VA (US)

(21) Appl. No.: 16/176,287

(22) Filed: Oct. 31, 2018

(51) Int. Cl. A47J 31/10; A47J 31/52; A47J 31/44; A47J 31/06; A23F 5/26

(52) U.S. Cl. CPC A47J 31/10; A47J 31/52; A23F 5/26; A47J 31/06; A47J 31/4439

(57) ABSTRACT

An automated drip beverage maker includes a base having a platform, a vertical arm extending upwardly from the base, and a head extending generally horizontally from an upper end of the arm. The platform includes a heating element electrically connected to a power source. The base further includes a reservoir and a conduit fluidly connected to the reservoir, the conduit being routed adjacent the heating element. The automated drip beverage maker further comprises a brew basket assembly pivotally attached to the head. The brew basket assembly includes a brew basket and the brew basket assembly is movable between a brewing position, in which the brew basket is directly beneath the head and located to receive fluid from the conduit, and an access position, in which the brew basket is pivoted to a position beside the head to enable access to the brew basket. The brew basket assembly further comprises an integrated display panel electrically connected with the heating element.

### FIELD OF THE INVENTION

The present invention is directed generally to beverage makers, and more specifically to automatic drip beverage makers.

### BACKGROUND

Automatic drip coffee makers are effective to brew carafes of coffee, typically containing four to twelve cups of liquid. Automatic drip coffee makers may also be used for brewing smaller batches, and some coffee makers include known modifications and adjustments to hot water flow rates to improve the quality of the brewed beverage in small batches.

A typical automatic drip coffee maker includes a brew basket that contains ground coffee (presented loosely in a bowl-shaped filter or within a “pod”-type package). Heated water is conveyed to the brew basket and released, where it gravimetrically flows downwardly through the coffee grounds and into a receptacle such as a carafe or pot. Exemplary automatic drip coffee maker are discussed in U.S. Pat. No. 5,001,969 to Moore et al.; U.S. Pat. No. 7,066,080 to Hsu; and U.S. Pat. No. 8,065,952 to Wang, the disclosures of which are hereby incorporated herein by reference in full.

In some designs, the brew basket is detachable from the coffee maker; it may be captured on rails and slide on the rails into and out of position for brewing. This design encourages loading of the brew basket with a filter and coffee when the brew basket is detached. In other designs, the brew basket is attached to the remainder of the coffee maker via a hinge or the like, which enables the brew basket to swing into and out of brewing position, which prevents the brew basket from being lost or misplaced. These choices limit other functional aspects of the coffee maker.

There may be a need or desire for automatic drip coffee makers to include additional functionality.

### SUMMARY

As a first aspect, embodiments of this disclosure are directed to an automatic drip beverage maker. The automated drip beverage maker comprises a base having a platform, a vertical arm extending upwardly from the base, and a head extending generally horizontally from an upper end of the arm. The platform includes a heating element electrically connected to a power source. The base further includes a reservoir and a conduit fluidly connected to the reservoir, the conduit being routed adjacent the heating element. The automated drip beverage maker further comprises a brew basket assembly pivotally attached to the head. The brew basket assembly includes a brew basket and the brew basket assembly is movable between a brewing position, in which the brew basket is directly beneath the head and located to receive fluid from the conduit, and an access position, in which the brew basket is pivoted to a position beside the head to enable access to the brew basket. The brew basket assembly further comprises an integrated display panel electrically connected with the heating element.

As a second aspect, embodiments of this disclosure are directed to an automatic drip beverage maker comprising a base having a platform, a vertical arm extending upwardly from the base, and a head extending generally horizontally from an upper end of the arm. The platform includes a heating element electrically connected to a power source. The base further includes a reservoir and a conduit fluidly connected to the reservoir, the conduit being routed adjacent the heating element. The automatic drip beverage maker further comprises a brew basket assembly pivotally attached to the head about a substantially vertical axis, the brew basket assembly including a brew basket. The brew basket assembly is movable between a brew position, in which the brew basket is directly beneath the head and located to receive fluid from the conduit, and an access position, in which the brew basket is pivoted to a position beside the head to enable access to the brew basket. The brew basket assembly further comprises an integrated display panel electrically connected with the heating element.

As a third aspect, embodiments of this disclosure are directed to an automatic drip beverage maker comprising: a base having a platform, a vertical arm extending upwardly from the base, and a head extending generally horizontally from an upper end of the arm. The platform includes a heating element electrically connected to a power source, and the base further includes a reservoir and a conduit fluidly connected to the reservoir, the conduit being routed adjacent the heating element. The automatic drip beverage maker further comprises a brew basket assembly pivotally attached to the head, the brew basket assembly including a brew basket. The brew basket assembly is movable between a brew position, in which the brew basket is directly beneath the head and located to receive fluid from the conduit, and an access position, in which the brew basket is pivoted to a position beside the head to enable access to the brew basket. The brew basket assembly further comprises an integated display panel electrically connected with the heating element via wiring, and a sealing hose extends between the brew basket and the base, the wiring being routed through the sealing hose.

### BRIEF DESCRIPTION OF THE FIGURES

FIG. 1 is a side perspective view of an automatic drip beverage maker according to embodiments of the invention, shown with the brew basket assembly in the brewing position.

FIG. 2 is a front perspective view of the automatic drip beverage maker of FIG. 1, shown with the brew basket assembly in the access position.

FIG. 3 is a side perspective view of the automatic drip beverage maker of FIG. 1, shown with the brew basket assembly in the access position.

FIG. 4 is a top section view of the automatic drip beverage maker of FIG. 1, shown with the brew basket assembly in the brewing position.

FIG. 5 is a top section view of the automatic drip beverage maker of FIG. 1, shown with the brew basket in the access position.

FIG. 6 is a partial bottom perspective section view of the automatic drip beverage maker of FIG. 1 showing the heating elements and conduits in the base.

FIG. 7 is a partial top section view of the automatic drip beverage maker of FIG. 1, shown with the brew basket in the access position.

FIG. 8 is a partial side perspective view of the automatic drip beverage maker of FIG. 1, shown with the brew basket assembly in the brewing position, and illustrating the path of the conduit between the reservoir and the drip shower.

### DETAILED DESCRIPTION

The present invention will now be described more fully hereinafter, in which embodiments of the invention are shown. This invention may, however, be embodied in different forms and should not be construed as limited to the embodiments set forth herein. Rather, these embodiments are provided so that this disclosure will be thorough and complete, and will fully convey the scope of the invention to those skilled in the art. In the drawings, like numbers refer to like elements throughout. Thicknesses and dimensions of some components may be exaggerated for clarity.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein the expression “and/or” includes any and all combinations of one or more of the associated listed items.

In addition, spatially relative terms, such as “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. The device may be otherwise oriented (rotated 90 degrees or at other orientations) and the spatially relative descriptors used herein interpreted accordingly.

Well-known functions or constructions may not be described in detail for brevity and/or clarity.

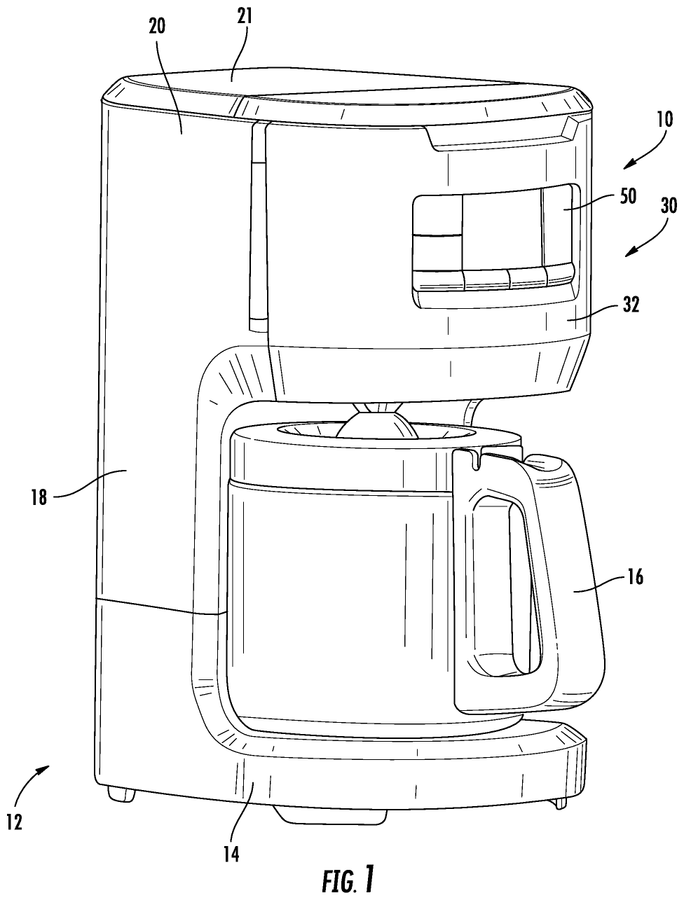

Referring now to the figures, an automatic drip coffee maker, designated broadly at 10, is shown in FIG. 1. The coffee maker 10 includes a base 12 that features a platform 14 on which a pot 16 can rest during brewing. A vertical arm 18 rises from the platform 14. A head 20 is mounted in cantilever fashion at the top of the arm 18 and extends over the pot 16 and platform 14. A brew basket assembly 30 (discussed in greater detail below) is pivotally mounted to the head 20.

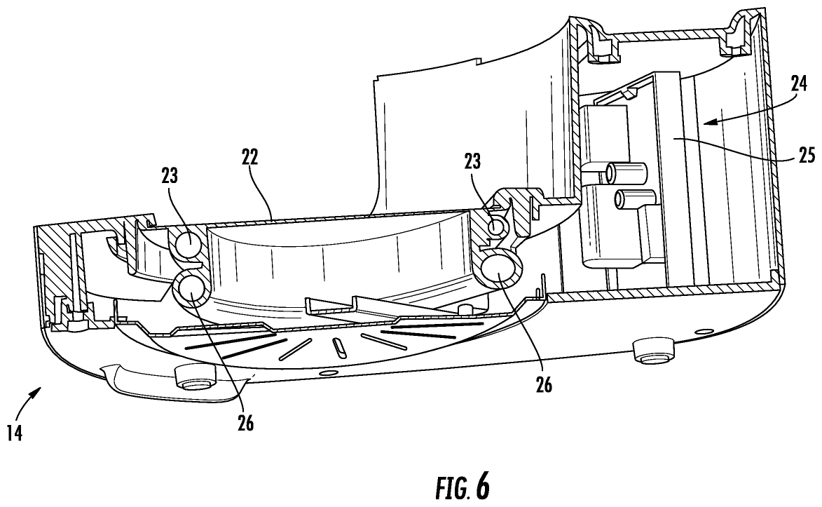

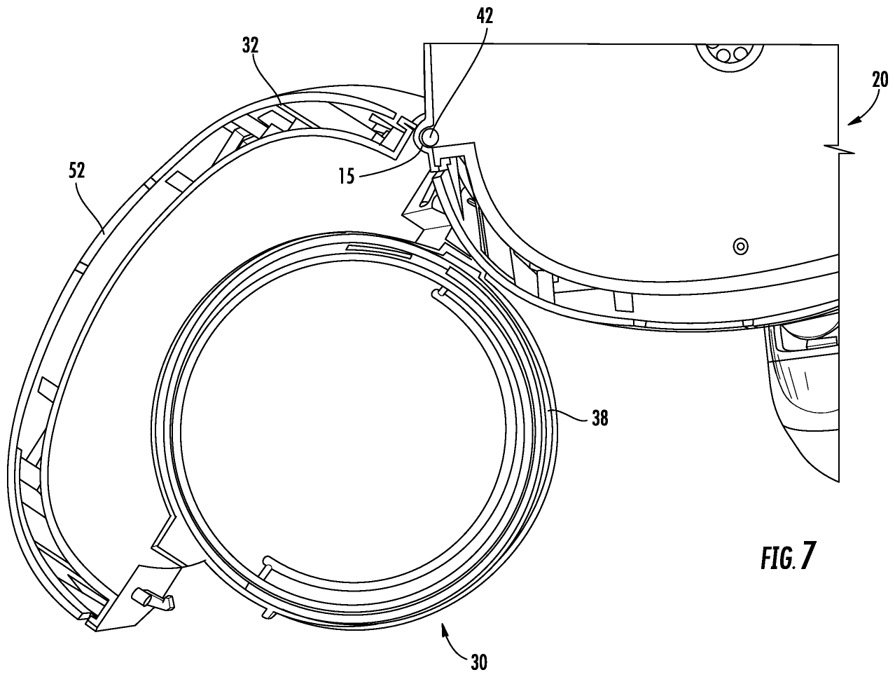

Components typically employed by automated drip coffee makers are contained in the base 12. These may include, but not be limited to, a water reservoir 21 (which can be seen in FIGS. 4, 5 and 8, and which occupies space within the arm 18 and the head 20), a heating element 23, which as illustrated is typically located in the platform 14 below a warming plate 22 (FIGS. 6 and 8), a power assembly 24, which typically includes a power cord (not shown) adapted for insertion into an electrical outlet and a power converter 25 (FIGS. 6 and 8) that is connected to the heating element 23, one or more tubes or conduits 26 for conveying water from the reservoir 21 past the heating element 23 to a drip shower 29 above the brew basket assembly 30, and the like. These components may be of conventional construction and function and need not be described in detail herein.

Also, although the term “coffee maker” is used herein, the coffee maker 10 may be configured to brew other brewed beverages, such as tea and cider, in addition to coffee as well as to provide a source of potable hot water. The term “beverage maker” is intended to include devices that brew coffee as well as other beverages and/or provide a source of hot water.

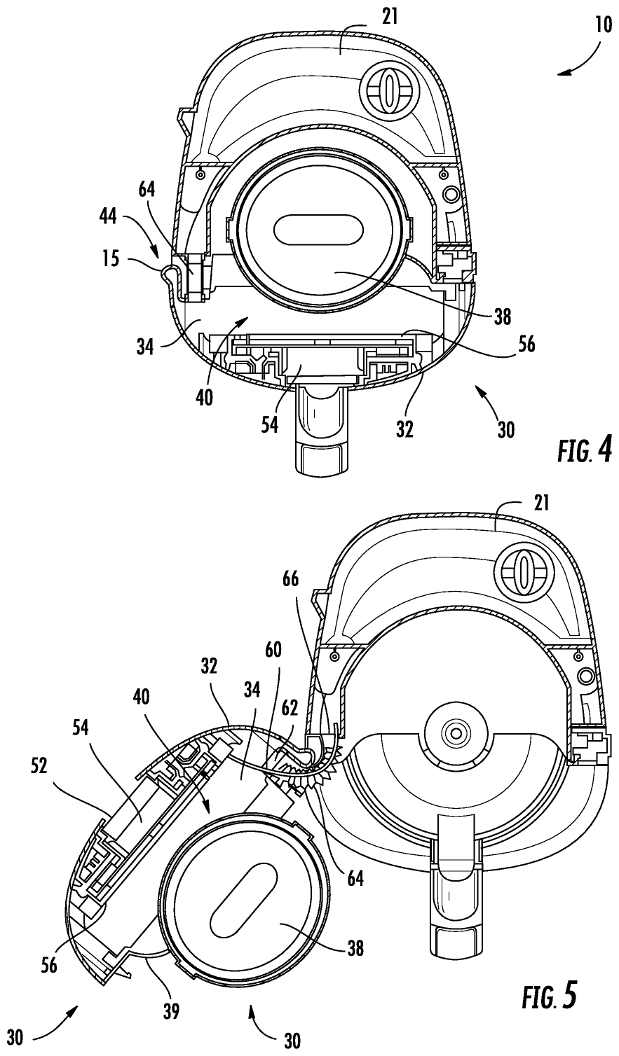

Referring to FIGS. 1-3, the brew basket assembly 30 includes a semi-ovoid front facing 32. A floor 34 is integral with and extends horizontally inwardly away from the front facing 32. A conical brew basket 38 is positioned inwardly of the floor 34. The brew basket 38 is open at its lower end to enable brewed coffee to drip into the pot 16 below. Side walls 39 span the edges of the front facing 32 and the brew basket 38, and a ceiling 36 extends between the brew basket 38 and the inner surface of the front facing 32. The front facing 32, the floor 34, the ceiling 36, the brew basket 38 and the side walls 39 together form a compartment 40 (see FIGS. 4 and 5) within the brew basket assembly 30.

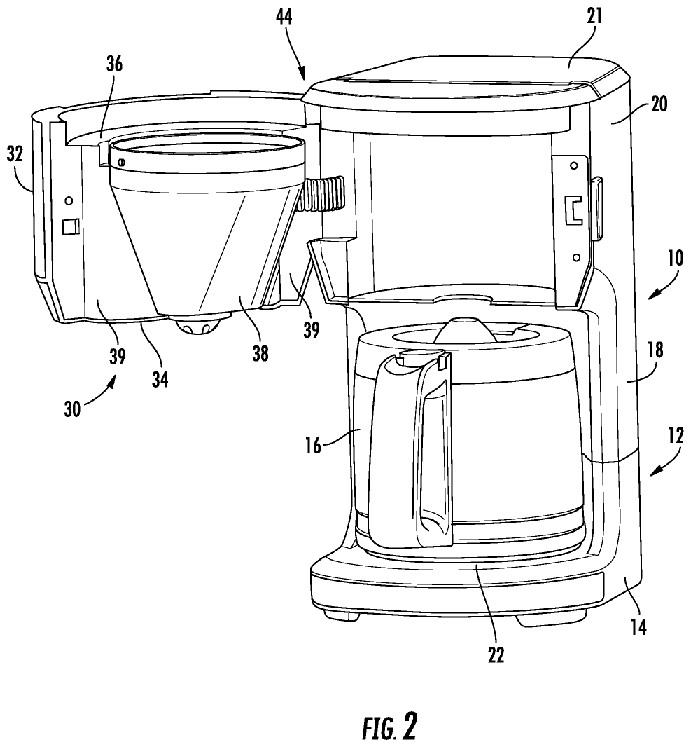

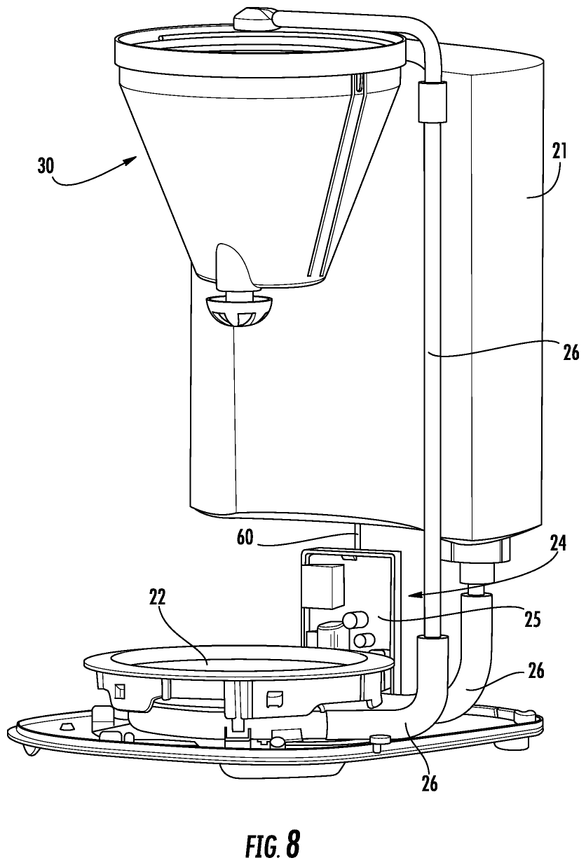

As can be understood from FIGS. 1-5 and 7, the brew basket assembly 30 is pivotally attached to the base 12 via a hinge 44 formed by bosses 15 on the base 12 that receive vertical posts 42 on the brew basket assembly 30. The hinge 44 enables the brew basket assembly 30 to pivot between an access position (shown in FIGS. 2, 3, 5 and 7), in which the brew basket assembly 30 is positioned away from the head 20 to render the brew basket 38 accessible for the loading/unloading of coffee grounds, and a brewing position (shown in FIGS. 1, 4 and 8), in which the brew basket assembly 30 is pivoted beneath the forward portion of the head 20, thereby locating the brew basket 38 in position for brewing.

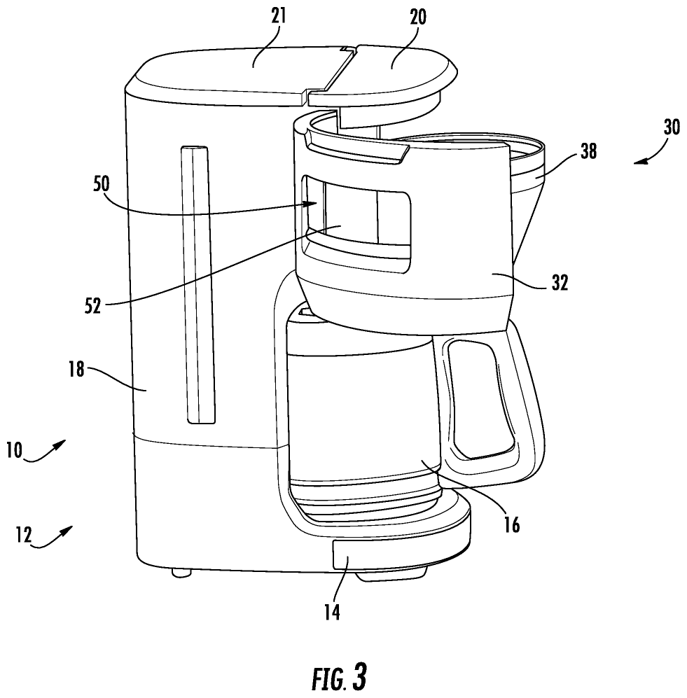

Referring now to FIGS. 1 and 3, it can be seen that a display panel 50 is mounted on the front facing 32 of the brew basket assembly 30. The display panel 50, which in the illustrated embodiment is an LCD panel, includes a touch screen 52 that typically includes a number of indicia or “buttons” for controlling operation of the coffee maker 10; these may include a power or “on/off” indicator, one or more brew duration or “strength” settings, a brew volume setting (e.g., “1 cup”, “2 cups”, etc.), potential additives, a time/date display, a timer, or the like.

As can be seen in FIGS. 4 and 5, a printed circuit board assembly (PCBA) 54 is connected with and controls the operation of the display panel 50. The PCBA 54 is contained within a housing 56 that seals the PCBA 54 therein. The housing 56 is mounted vertically within the compartment 40 of the brew basket 30.

Wiring 60 is electrically connected to the PCBA 54 and is routed out of the housing 56. From there the wiring 60 is routed from the compartment 40 through an aperture 62 in the side wall 39 nearest the hinge 44. A flexible sealing hose 64 extends from the aperture 62 to an aperture 66 in the outer housing of the head 20; the wiring 60 is routed through the sealing hose 64 and the aperture 66 into the head 20, from where it is routed to connect with the power assembly 24 (which in turn is electrically connected with the heating element 23 in the base 12). The sealing hose 64 is sealed as it travels through both the aperture 62 and the aperture 66 to protect the wiring 60. As shown in FIGS. 4 and 5, the sealing hose 64 has an accordion-style profile, which allows it to expand and contract in length; thus, as the brew basket assembly 30 pivots between the access and brewing positions of FIGS. 4 and 5, the sealing hose 64 can stretch and bend as needed while still protecting the wiring 60.

The presence of the display 50 on the brew basket assembly 30 can provide performance advantages to the coffee maker 10. First, the display 50 is located on the upper front portion of the coffee maker 10, a very convenient position for a user when the coffee maker 10 rests on a kitchen countertop. Second, the display 50 is able to utilize space on the front of the coffee maker 10 (namely, the front surface of the brew basket assembly 30) that may otherwise be unused; as a result, the display 50 may be larger than is ordinarily used. Third, because of this location, the display 50 may, in some embodiments, be suitable for providing additional functionality, such as displaying messages between family members, providing access to a BLUETOOTH device on the PCBA 54 for remote operation of the coffee maker 10, or the like.

Notably, the sealing hose 64 protects the wiring 60 from water, coffee, and other environmental conditions that could negatively impact its performance. Similarly, the housing 56 protects the PCBA 54 from similar, potentially detrimental conditions. Thus, concerns about exposure of either the display 50 or the wiring 60 to the typical hazards of hot coffee/water may be addressed with embodiments of the present invention.

Those of skill in this art will appreciate that the coffee maker 10 may take other forms. For example, the base 12, arm 18, and/or head 20 may take different configurations. A different size or style of pot 16 may be used. The platform 14 may lack a warming plate 22. The reservoir 21 may be located or configured differently. The tubes/conduits 26 that provide a pathway for water from the reservoir 21 to the heating element 23 and subsequently to the brew basket 38 may be formed or routed differently.

Moreover, the arrangement of the display 50 and wiring 60 may vary. For example, the PCBA 54 may be horizontally disposed (rather than vertically), shaped differently, or located within a different protective element than the housing 56 (for example, a protective casing similar to the housing 56 may be formed in the rear surface of the front facing 32). The sealing hose 64 may expand and contract in length via a different mechanism, such as a telescoping mechanism, or may not vary in length. The touch screen 52 may be replaced with a different variety of display.

The foregoing is illustrative of the present invention and is not to be construed as limiting thereof. Although exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. The invention is defined by the following claims, with equivalents of the claims to be included therein.

That which is claimed is:

1. An automatic drip beverage maker, comprising:
a base having a platform, a vertical arm extending upwardly from the base, and a head extending generally horizontally from an upper end of the arm;
wherein the platform includes a heating element electrically connected to a power source; and
wherein the base further includes a reservoir and a conduit fluidly connected to the reservoir, the conduit being routed adjacent the heating element;
a brew basket assembly pivotally attached to the head, the brew basket assembly including a brew basket, the brew basket assembly movable between a brew position, in which the brew basket is directly beneath the head and located to receive fluid from the conduit, and an access position, in which the brew basket is pivoted to a position beside the head to enable access to the brew basket;
the brew basket assembly further comprising a display panel electrically connected with the heating element.

2. The beverage maker defined in claim 1, further comprising a sealing hose extending between the brew basket and the base and wiring routed through the sealing hose.

3. The beverage maker defined in claim 2, wherein the display panel includes a printed circuit board assembly, and wherein the wiring is routed from the printed circuit board assembly to the sealing hose.

4. The beverage maker defined in claim 3, wherein the display panel is separated and protected from the brew basket by a housing.

5. The beverage maker defined in claim 1, wherein the display panel includes a touch screen.

6. The beverage maker defined in claim 5, wherein the touch screen includes indicia corresponding to operations selected from the group consisting of: a power indicator, brew duration, brew volume, additives, a time/date display, and a timer.

7. The beverage maker defined in claim 1, wherein the platform further includes a heating plate above the heating element.

8. An automatic drip beverage maker, comprising:
a base having a platform, a vertical arm extending upwardly from the base, and a head extending generally horizontally from an upper end of the arm;
wherein the platform includes a heating element electrically connected to a power source; and
wherein the base further includes a reservoir and a conduit fluidly connected to the reservoir, the conduit being routed adjacent the heating element;
a brew basket assembly pivotally attached to the head about a substantially vertical axis, the brew basket assembly including a brew basket, the brew basket assembly movable between a brew position, in which the brew basket is directly beneath the head and located to receive fluid from the conduit, and an access position, in which the brew basket is pivoted to a position beside the head to enable access to the brew basket;
the brew basket assembly further comprising a display panel electrically connected with the heating element.

9. The beverage maker defined in claim 8, further comprising a sealing hose extending between the brew basket and the base and wiring routed through the sealing hose.

10. The beverage maker defined in claim 9, wherein the sealing hose partially encircles the substantially vertical axis when the brew basket assembly is in the access position.

11. The beverage maker defined in claim 8, wherein the display panel includes a printed circuit board assembly, and wherein the wiring is routed from the printed circuit board assembly to the sealing hose.

12. The beverage maker defined in claim 8, wherein the display panel is separated and protected from the brew basket by a housing.

13. The beverage maker defined in claim 8, wherein the display panel includes a touch screen.

14. The beverage maker defined in claim 13, wherein the touch screen includes indicia corresponding to operations selected from the group consisting of: a power indicator, brew duration, brew volume, additives, a time/date display, and a timer.

15. The beverage maker defined in claim 8, wherein the platform further includes a heating plate above the heating element.

16. An automatic drip beverage maker, comprising:
a base having a platform, a vertical arm extending upwardly from the base, and a head extending generally horizontally from an upper end of the arm;
wherein the platform includes a heating element electrically connected to a power source; and
wherein the base further includes a reservoir and a conduit fluidly connected to the reservoir, the conduit being routed adjacent the heating element;
a brew basket assembly pivotally attached to the head, the brew basket assembly including a brew basket, the brew basket assembly movable between a brew position, in which the brew basket is directly beneath the head and located to receive fluid from the conduit, and an access position, in which the brew basket is pivoted to a position beside the head to enable access to the brew basket;
the brew basket assembly further comprising a display panel electrically connected with the heating element via wiring, and a sealing hose extends between the brew basket and the base, the wiring being routed through the sealing hose.

17. The beverage maker defined in claim 16, wherein the display panel includes a printed circuit board assembly, and wherein the wiring is routed from the printed circuit board assembly to the sealing hose.

18. The beverage maker defined in claim 17, wherein the display panel is separated and protected from the brew basket by a housing.

19. The beverage maker defined in claim 16, wherein the display panel includes a touch screen.

20. The beverage maker defined in claim 19, wherein the touch screen includes indicia corresponding to operations selected from the group consisting of: a power indicator, brew duration, brew volume, additives, a time/date display, and a timer.
